(19) United States
(12) Patent Application Publication
(10) Pub. No.: US 2018/0275020 A1
(43) Pub. Date: Sep. 27, 2018

(54) METHOD AND APPARATUS FOR CATALYST SAMPLING

(71) Applicant: UOP LLC, Des Plaines, IL (US)

(72) Inventors: Andrew S. Bruss, Chicago, IL (US); Pelin Cox, Des Plaines, IL (US); Joseph A. Zmich, Hanover Park, IL (US); Angelo P. Furfaro, Arlington Heights, IL (US); Jeffrey M. Wery, Arlington Heights, IL (US)

(21) Appl. No.: 15/994,929

(22) Filed: May 31, 2018

Related U.S. Application Data
(63) Continuation of application No. PCT/US2016/063061, filed on Nov. 21, 2016.
(60) Provisional application No. 62/268,048, filed on Dec. 16, 2015.

(51) Int. Cl. G01N 1/20

(52) U.S. Cl. CPC G01N 1/2035; G01N 2001/1018

(57) ABSTRACT

The present subject matter relates generally to methods and an apparatus for catalyst sampling for measuring and testing. More specifically, the present subject matter relates to methods for sampling a catalyst where solid material samplers are used in between reactors or regeneration zones to gain knowledge of the state of the catalyst at different points in the hydrocarbon conversion process.

### CROSS-REFERENCE TO RELATED APPLICATIONS

This application is a Continuation of copending International Application No. PCT/US2016/063061 filed Nov. 21, 2016, which application claims priority from U.S. Provisional Application No. 62/268,048 filed Dec. 16, 2015, now expired, the contents of which cited applications are hereby incorporated by reference in their entirety.

### FIELD

The present subject matter relates generally to methods and an apparatus for catalyst sampling for measuring and testing. More specifically, the present subject matter relates to methods for sampling a catalyst where solid material samplers are used in between reactors or regeneration zones to gain knowledge of the state of the catalyst at different points in the hydrocarbon conversion process.

### BACKGROUND

There are many situations in which there is great utility in being able to sample solid particles contained in a storage vessel, reactor, or in between reactors in a continuous process.

Some examples of this are the sampling of grains stored within an elevator, sampling of particles of cement or other aggregate used in the construction industries, sampling of solid catalyst particles being manufactured or regenerated, or the withdrawal of catalyst samples from a reactor in use. In processes for the catalytic conversion of hydrocarbons by contacting the hydrocarbon feed stock with a bed of catalyst maintained at conversion conditions, as typical in reforming, dehydrogenation, dehydrocyclodimerization, hydrodesulferization or paraffin isomerization, it is often desired to determine the condition of the catalyst. An important reason for this is to gain a better knowledge of the mechanisms of the deactivation which is occurring to the catalyst. A few examples of this evaluation would include determining the coke content, amount of metal deposition, changes in the porous structure or surface characteristics of the catalyst, and measurements of the loss of a specific constituent of the catalyst, such as acidity or volatile halogens.

Robust catalyst activity and stability is crucial to preventing off spec products and premature shutdowns due to irreversible damage to the catalyst and/or equipment which can have immense economical consequences. Ability to continuously sample and monitor the catalyst helps with early identification of issues, troubleshooting and finally a proactive approach to treatments necessary to restoring and maintaining catalyst activity and stability and to protect equipment.

### SUMMARY

Hydrocarbons, and in particular petroleum, are produced from the ground as a mixture. This mixture is converted to useful products through separation and processing of the streams in reactors and separation equipment. The conversion of the hydrocarbon streams to useful products is often through a catalytic process in a reactor. The catalysts can be solid or liquid, and can comprise catalytic materials. In bi-functional catalysis catalytic materials of acid such as zeolite and metals such as those in transition and main groups are combined to form a composite to facilitate the conversion process such as the one described in this subject application. During the processing of the hydrocarbons, the catalysts deactivate over time. One example of deactivation is the generation and buildup of coke on the catalyst. The accumulation of coke covers or blocks access to catalytic sites on the catalyst. The regeneration of the catalyst is normally performed through the removal of the coke, where the coke is combusted at a high-temperature with a gas having oxygen. It is a crucial advantage to be able to sample the catalyst at different points in the process to determine and optimize regeneration methods and/or determine if the regeneration was successful. Being able to sample the catalyst in between the reactors and regeneration zones improves the process by ensuring robust catalyst activity and stability.

A first embodiment of the invention is a method of sampling solid particles comprising feeding solid particles to a first tube; removing a sample of the solid particles thereby generating remaining solid particles; passing a first gas stream comprising gas to the first tube; passing the remaining solid particles from the first tube to a second tube; and passing a second gas stream comprising gas to the second tube, thereby pushing the remaining solid particles upward through the second tube to a reactor section. An embodiment of the invention is one, any or all of prior embodiments in this paragraph up through the first embodiment in this paragraph, wherein the first tube includes a vertical upper portion and a curved lower portion, wherein the curved lower portion is coupled to the second tube. An embodiment of the invention is one, any or all of prior embodiments in this paragraph up through the first embodiment in this paragraph, wherein the second tube comprises a lower vertical portion and an upper vertical portion. An embodiment of the invention is one, any or all of prior embodiments in this paragraph up through the first embodiment in this paragraph, wherein the first gas stream comprises H₂, N₂, or low purity H₂ having some residual hydrocarbons such as methane, or mixtures thereof. An embodiment of the invention is one, any or all of prior embodiments in this paragraph up through the first embodiment in this paragraph, wherein the second gas stream comprises H₂, N₂, or low purity H₂ having some residual hydrocarbons such as methane, or mixtures thereof. An embodiment of the invention is one, any or all of prior embodiments in this paragraph up through the first embodiment in this paragraph, wherein the reactor section comprises a series of reactors and a regeneration section wherein the regeneration section may be comprised of different zones.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### DEFINITIONS

As used herein, the term “stream”, “feed”, “product”, “part” or “portion” can include various hydrocarbon molecules, such as straight-chain, branched, or cyclic alkanes, alkenes, alkadienes, and alkynes, and optionally other substances, such as gases, e.g., hydrogen, or impurities, such as heavy metals, and sulfur and nitrogen compounds. The stream can also include aromatic and non-aromatic hydrocarbons. Moreover, the hydrocarbon molecules may be abbreviated C₁, C₂, C₃, Cn where “n” represents the number of carbon atoms in the one or more hydrocarbon molecules or the abbreviation may be used as an adjective for, e.g., non-aromatics or compounds. Similarly, aromatic compounds may be abbreviated A₆, A₇, A₈, An where “n” represents the number of carbon atoms in the one or more aromatic molecules. Furthermore, a superscript “+” or “−” may be used with an abbreviated one or more hydrocarbons notation, e.g., C₃₊ or C₃₋, which is inclusive of the abbreviated one or more hydrocarbons. As an example, the abbreviation “C₃₊” means one or more hydrocarbon molecules of three or more carbon atoms.

As used herein, the term “zone” can refer to an area including one or more equipment items and/or one or more sub-zones. Equipment items can include, but are not limited to, one or more reactors or reactor vessels, separation vessels, distillation towers, heaters, exchangers, tubes, pumps, compressors, and controllers. Additionally, an equipment item, such as a reactor, dryer, or vessel, can further include one or more zones or sub-zones.

The term “communication” means that material flow is operatively permitted between enumerated components.

The term “downstream communication” means that at least a portion of material flowing to the subject in downstream communication may operatively flow from the object with which it communicates.

The term “upstream communication” means that at least a portion of the material flowing from the subject in upstream communication may operatively flow to the object with which it communicates.

The term “direct communication” means that flow from the upstream component enters the downstream component without undergoing a compositional change due to physical fractionation or chemical conversion.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is an illustration of the overall flow scheme and where the catalyst sampling apparatus may be located.

FIG. 2 is a cross-sectional view of a vessel embodying the present invention.

### DETAILED DESCRIPTION

The following detailed description is merely exemplary in nature and is not intended to limit the application and uses of the embodiment described. Furthermore, there is no intention to be bound by any theory presented in the preceding background or the following detailed description.

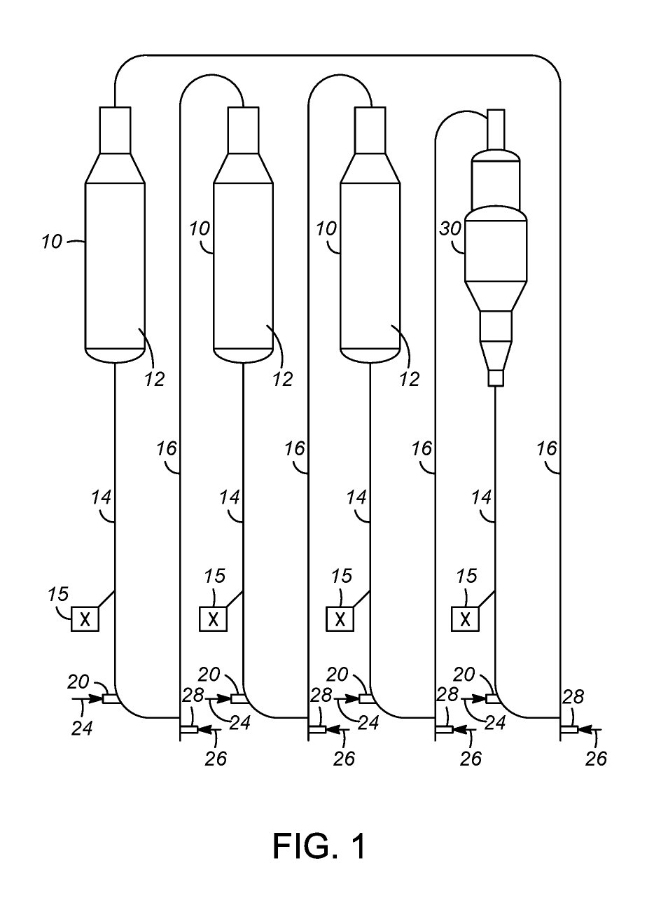

FIG. 1 illustrates a diagram of various embodiments of the processes described herein. Those skilled in the art will recognize that this process flow diagram has been simplified by the elimination of many pieces of process equipment including for example, heat exchangers, process control systems, pumps, fractionation column overhead, reboiler systems and reactor internals, etc. which are not necessary to an understanding of the process. It may also be readily discerned that the process flow presented in the drawing may be modified in many aspects without departing from the basic overall concept. For example, the depiction of required heat exchangers in the drawing has been held to a minimum for purposes of simplicity. Those skilled in the art will recognize that the choice of heat exchange methods employed to obtain the necessary heating and cooling at various points within the process is subject to a large amount of variation as to how it is performed. In a process as complex as this, there exists many possibilities for indirect heat exchange between different process streams. Depending on the specific location and circumstance of the installation of the subject process, it may also be desired to employ heat exchange against steam, hot oil, or process streams from other processing units not shown on the drawing.

With reference to FIG. 1, an apparatus and process in accordance with various embodiments includes a series of reactors 10 and a regenerator 30. However, it is contemplated that any number of reactors, reaction zones, or regeneration zones may be used and the catalyst sampling may take place in between any of these zones. In the example illustrated in FIG. 1, a stream of spent catalyst particles 12 is continuously introduced to the reactor 10. Although the term continuous is applied to this process herein, the process may include a continuous, semi-continuous, or batch process where small amounts of catalyst are withdrawn from the reactor and passed to the stripping zone on a relatively continuous basis. The catalyst particles 12 flow downward through the reactors 10. The catalyst particles 12 may exit from a reactor. The reactor may be a dehydrogenation reactor, a reforming reactor, a dehydrocyclodimerization reactor, or any other reactor used in the conversion of hydrocarbons. As catalyst particles 12 flow down through the reactor 10, the catalyst particles 12 are directed into the first tube 14.

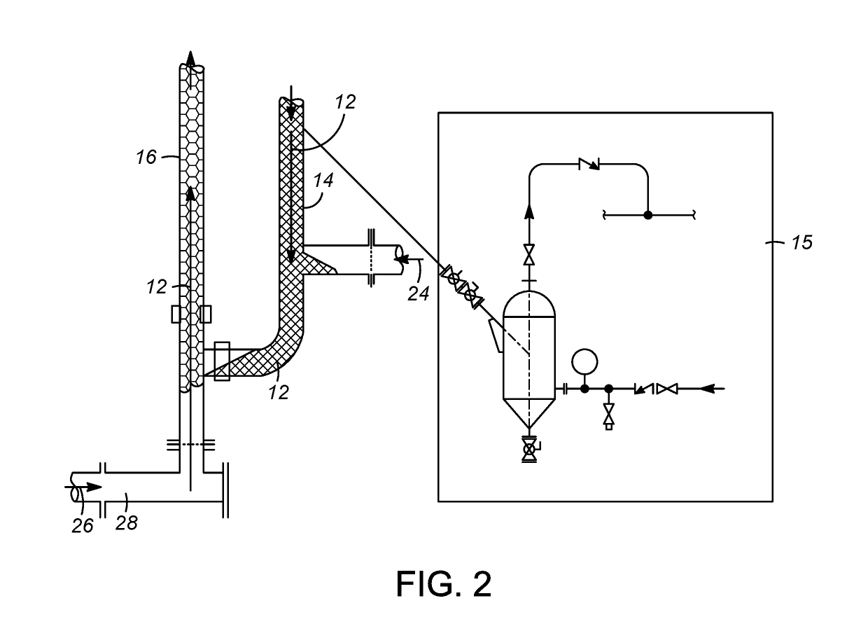

With reference to FIG. 2, in the first tube 14, the catalyst particles 12 flow down through the first tube 14 at a rate to provide sufficient time for the catalyst particles 12 to be thoroughly sampled. The catalyst particles 12 are sampled by a catalyst sampling system 15. The catalyst sampling system 15 may be located at any point along the first tube 14. Any standard catalyst sampling system may be used. Once the catalyst particles 12 have been sampled, they may be suitable for lifting. As illustrated in the example in FIG. 1, two lift gases are used, the first gas stream 24 and the second gas stream 26. However, it is contemplated that one or more than two lift gases may be used in alternative embodiments.

A first gas stream 24 may be cycled through the first tube 14 using a blower for circulation of the gas or a higher pressure gas in the process not requiring a blower or compressor. The first gas stream 24 may assist the movement of the catalyst particles through the fist tube 14. As the first tube 14 includes curved bottom portion as it connects the second tube 16. The curved portion of the first tube 14 allows for the catalyst particles to flow using gravity to the bottom of the first tube 14 and allows for the catalyst particles to enter the second tube 16. The first gas may also be cycled using a compressor. The first gas may include hydrogen. However, it is also contemplated that the gas may include H₂, N₂, or low purity H₂ having some residual hydrocarbons such as methane, or mixtures thereof.

The catalyst particles 12 travel further and flow from the first tube 14 to the second tube 16, where the catalyst is contacted with a second gas stream 26 for directing the catalyst particles 12 upward through the second tube 16. The second gas 26 enters through the inlet 28 and is cycled through the second tube 16 using a blower for circulation of the gas or a higher pressure gas in the process not requiring a blower or compressor. The second gas 26 may also be cycled using a compressor. The second gas may include hydrogen. However, it is also contemplated that the gas may include H₂, N₂, or low purity H₂ having some residual hydrocarbons such as methane, or mixtures thereof.

As illustrated in FIG. 1, as catalyst particles 12 flow up through the second tube 16 the catalyst particles 12 are directed upward back to the reactor 10 or regenerator 30. After the second gas 26 enters the second tube 16 through the inlet 28 the second gas 26 is directed upward and then the second gas 26 enters the reactor 10 or the regenerator 30.

An advantage of the catalyst sampling process is that sampling and lifting of the catalyst in two or more separate zones can effectively allow for testing of the catalyst without disrupting operation, therefore preventing downstream equipment issues. Any suitable catalyst that may be used in a hydrocarbon conversion process may be utilized.

It should be noted that various changes and modifications to the presently preferred embodiments described herein will be apparent to those skilled in the art. Such changes and modifications may be made without departing from the spirit and scope of the present subject matter and without diminishing its attendant advantages.

### SPECIFIC EMBODIMENTS

While the following is described in conjunction with specific embodiments, it will be understood that this description is intended to illustrate and not limit the scope of the preceding description and the appended claims.

A first embodiment of the invention is a method of sampling solid particles comprising feeding solid particles to a first tube; removing a sample of the solid particles thereby generating remaining solid particles; passing a first gas stream comprising gas to the first tube; passing the remaining solid particles from the first tube to a second tube; and passing a second gas stream comprising gas to the second tube, thereby pushing the remaining solid particles upward through the second tube to a reactor or regeneration section. An embodiment of the invention is one, any or all of prior embodiments in this paragraph up through the first embodiment in this paragraph, wherein the first tube includes a vertical upper portion and a curved lower portion, wherein the curved lower portion is coupled to the second tube. An embodiment of the invention is one, any or all of prior embodiments in this paragraph up through the first embodiment in this paragraph, wherein the second tube comprises a lower vertical portion and an upper vertical portion. An embodiment of the invention is one, any or all of prior embodiments in this paragraph up through the first embodiment in this paragraph, wherein the first gas stream comprises H₂, N₂, or low purity H₂ having some residual hydrocarbons such as methane, or mixtures thereof. An embodiment of the invention is one, any or all of prior embodiments in this paragraph up through the first embodiment in this paragraph, wherein the second gas stream comprises H₂, N₂, or low purity H₂ having some residual hydrocarbons such as methane, or mixtures thereof. An embodiment of the invention is one, any or all of prior embodiments in this paragraph up through the first embodiment in this paragraph, wherein the reactor section comprises a series of reactors and a regeneration section wherein the regeneration section may be comprised of different zones.

A second embodiment of the invention is a method of sampling catalyst particles comprising feeding catalyst particles to a first tube; removing a sample of the catalyst particles thereby generating remaining catalyst particles; passing a first gas stream comprising gas to the first tube; passing the remaining catalyst particles from the first tube to a second tube; and passing a second gas stream comprising gas to the second tube, thereby pushing the remaining catalyst particles upward through the second tube to a reactor section. An embodiment of the invention is one, any or all of prior embodiments in this paragraph up through the second embodiment in this paragraph, wherein the first tube includes a vertical upper portion and a curved lower portion, wherein the curved lower portion is coupled to the second tube. An embodiment of the invention is one, any or all of prior embodiments in this paragraph up through the second embodiment in this paragraph, wherein the second tube comprises a lower vertical portion and an upper vertical portion. An embodiment of the invention is one, any or all of prior embodiments in this paragraph up through the second embodiment in this paragraph, wherein the first gas stream comprises H₂, N₂, or low purity H₂ having some residual hydrocarbons such as methane, or mixtures thereof. An embodiment of the invention is one, any or all of prior embodiments in this paragraph up through the second embodiment in this paragraph, wherein the second gas stream comprises H₂, N₂, or low purity H₂ having some residual hydrocarbons such as methane, or mixtures thereof. An embodiment of the invention is one, any or all of prior embodiments in this paragraph up through the second embodiment in this paragraph, wherein the reactor section comprises a series of reactors and a regeneration section wherein the regeneration section may be comprised of different zones. An embodiment of the invention is one, any or all of prior embodiments in this paragraph up through the second embodiment in this paragraph, wherein the catalyst particles may include any catalyst that may be used in a hydrocarbon conversion process. A sampling apparatus comprising a first tube wherein the first tube includes an upper portion and a lower portion wherein the upper portion is vertical and the upper portion is coupled to a sampling means, and the lower portion is curved and is coupled to a second tube; a second tube wherein the second tube includes a lower portion which is coupled to the lower portion of the first tube and the upper portion is coupled to a reactor section. The sampling apparatus of claim 1, wherein the sampling means includes a catalyst sampling device. The sampling apparatus of claim 15, wherein the catalyst sampling device may be located at any location along the upper portion of the first tube. The sampling apparatus of claim 1, further comprising a first lift gas inlet line wherein the first lift gas inlet line located on the lower portion of the first tube. The sampling apparatus of claim 1, further comprising a second lift gas inlet line wherein the second lift gas inlet line located on the lower portion of the second tube.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

1. A method of sampling solid particles comprising:
feeding solid particles to a first tube;
removing a sample of the solid particles thereby generating remaining solid particles;
passing a first gas stream comprising gas to the first tube;
passing the remaining solid particles from the first tube to a second tube; and
passing a second gas stream comprising gas to the second tube, thereby pushing the remaining solid particles upward through the second tube to a reactor section.

2. The method of claim 1, wherein the first tube includes a vertical upper portion and a curved lower portion, wherein the curved lower portion is coupled to the second tube.

3. The method of claim 1, wherein the second tube comprises a lower vertical portion and an upper vertical portion.

4. The method of claim 1, wherein the first gas stream comprises H₂, N₂, or low purity H₂ having some residual hydrocarbons such as methane, or mixtures thereof.

5. The method of claim 1, wherein the second gas stream comprises H₂, N₂, or low purity H₂ having some residual hydrocarbons such as methane, or mixtures thereof

6. The method of claim 1, wherein the reactor section comprises a series of reactors and a regeneration section wherein the regeneration section may be comprised of different zones.

7. A method of sampling catalyst particles comprising:
feeding catalyst particles to a first tube;
removing a sample of the catalyst particles thereby generating remaining catalyst particles;
passing a first gas stream comprising gas to the first tube;
passing the remaining catalyst particles from the first tube to a second tube; and
passing a second gas stream comprising gas to the second tube, thereby pushing the remaining catalyst particles upward through the second tube to a reactor section.

8. The method of claim 7, wherein the first tube includes a vertical upper portion and a curved lower portion, wherein the curved lower portion is coupled to the second tube.

9. The method of claim 7, wherein the second tube comprises a lower vertical portion and an upper vertical portion.

10. The method of claim 7, wherein the first gas stream comprises H₂, N₂, or low purity H₂ having some residual hydrocarbons such as methane, or mixtures thereof.

11. The method of claim 7, wherein the second gas stream comprises H₂, N₂, or low purity H₂ having some residual hydrocarbons such as methane, or mixtures thereof.

12. The method of claim 7, wherein the reactor section comprises a series of reactors and a regeneration section wherein the regeneration section may be comprised of different zones.

13. The method of claim 7, wherein the catalyst particles may include any catalyst that may be used in a hydrocarbon conversion process.

14. A sampling apparatus comprising:
a first tube wherein the first tube includes an upper portion and a lower portion wherein the upper portion is vertical and the upper portion is coupled to a sampling means, and the lower portion is curved and is coupled to a second tube; and
a second tube wherein the second tube includes a lower portion which is coupled to the lower portion of the first tube and the upper portion is coupled to a reactor section.

15. The sampling apparatus of claim 14, wherein the sampling means includes a catalyst sampling device.

16. The sampling apparatus of claim 14, wherein the catalyst sampling device may be located at any location along the upper portion of the first tube.

17. The sampling apparatus of claim 14, further comprising a first lift gas inlet line wherein the first lift gas inlet line located on the lower portion of the first tube.

18. The sampling apparatus of claim 14, further comprising a second lift gas inlet line wherein the second lift gas inlet line located on the lower portion of the second tube.
